(19) United States
(12) Patent Application Publication
(10) Pub. No.: US 2026/0005404 A1
(43) Pub. Date: Jan. 1, 2026

(54) INTEGRATED BUSBAR AND TERMINAL CONFIGURATION

(71) Applicant: Ford Global Technologies, LLC, Dearborn, MI (US)

(72) Inventors: Yongcai Wang, Ann Arbor, MI (US); Chi Paik, Grosse Ile, MI (US); Chung-Hsing Kuo, Ann Arbor, MI (US); Frank Kim, South Lyon, MI (US); Kwon Shon, Troy, MI (US)

(21) Appl. No.: 18/760,265

(22) Filed: Jul. 1, 2024

(51) Int. Cl. H01M 50/503; H01M 50/249; H01M 50/517; H01M 50/569

(52) U.S. Cl. CPC H01M 50/503; H01M 50/517; H01M 50/569; H01M 50/249

(57) ABSTRACT

A battery pack may include an array of battery cells. A battery pack may include an integrated component including a busbar portion and a terminal portion. The busbar portion is arranged adjacent an end of the array of battery cells, and the terminal portion provides a terminal of the battery pack.

### TECHNICAL FIELD

This disclosure relates generally to electrified vehicles, and more specifically relates to an integrated busbar and terminal.

### BACKGROUND

A high voltage traction battery pack typically powers the electric machines and other electrical loads of an electrified vehicle. The traction battery pack includes a plurality of battery cells. The battery cells must be reliably connected to one another in order to provide the voltage and power levels necessary for achieving vehicle propulsion.

### SUMMARY

In some aspects, the techniques described herein relate to a battery pack, including: an array of battery cells; and an integrated component including a busbar portion and a terminal portion, wherein the busbar portion is arranged adjacent an end of the array of battery cells, and wherein the terminal portion provides a terminal of the battery pack.

In some aspects, the techniques described herein relate to a battery pack, wherein: the busbar portion lies in a first plane, and the terminal portion lies in a second plane substantially perpendicular to the first plane.

In some aspects, the techniques described herein relate to a battery pack, wherein: the integrated component includes a connector section connecting the busbar portion and the terminal portion, the integrated component includes a first bend between the busbar portion and the connector section, the first bend extends along a first axis substantially parallel to the first plane, the integrated component includes a second bend between the connector section and the terminal portion, and the second bend extends along a second axis substantially perpendicular to the first plane.

In some aspects, the techniques described herein relate to a battery pack, wherein the connector section lies in a third plane substantially perpendicular to the first and second planes.

In some aspects, the techniques described herein relate to a battery pack, wherein the busbar portion includes: a substantially rectangular section configured to facilitate attachment of cell tabs to the substantially rectangular section, and an inclined section between the substantially rectangular section and the first bend.

In some aspects, the techniques described herein relate to a battery pack, wherein, adjacent the first bend, the integrated component includes a tongue configured for attachment to a voltage sensing circuit.

In some aspects, the techniques described herein relate to a battery pack, wherein the substantially rectangular section includes a first hole configured to receive a post, and the inclined section includes a second hole configured to receive another post.

In some aspects, the techniques described herein relate to a battery pack, wherein the terminal portion includes a hole configured to receive a connector.

In some aspects, the techniques described herein relate to a battery pack, wherein the integrated component is formed without any joints or seams.

In some aspects, the techniques described herein relate to a battery pack, wherein the integrated component is formed from a single manufacturing process.

In some aspects, the techniques described herein relate to a battery pack, wherein the manufacturing process is stamping.

In some aspects, the techniques described herein relate to a battery pack, wherein: the integrated component is a first integrated component, the battery pack further includes a second integrated component including a busbar portion and a terminal portion, and the busbar portion of the second integrated component is arranged adjacent an end of the array of battery cells opposite the end at which the busbar portion of the first integrated component is arranged.

In some aspects, the techniques described herein relate to a battery pack, wherein: the integrated component is a first integrated component, the battery pack further includes a second integrated component including a busbar portion and a terminal portion, the terminal portion of the first integrated component provides one of a positive terminal and a negative terminal of the battery pack, and the terminal portion of the second integrated component provides the other of the positive terminal and the negative terminal of the battery pack.

In some aspects, the techniques described herein relate to an integrated component for a battery pack of an electrified vehicle, including: a busbar portion; and a terminal portion, wherein the integrated component is formed without any joints or seams.

In some aspects, the techniques described herein relate to an integrated component, wherein: the busbar portion lies in a first plane, and the terminal portion lies in a second plane perpendicular to the first plane.

In some aspects, the techniques described herein relate to an integrated component, further including a connector section connecting the busbar portion and the terminal portion, and wherein: the integrated component includes a first bend between the busbar portion and the connector section, the first bend extends along a first axis substantially parallel to the first plane, the integrated component includes a second bend between the connector section and the terminal portion, and the second bend extends along a second axis substantially perpendicular to the first plane.

In some aspects, the techniques described herein relate to a method, including: forming an integrated component including a busbar portion and a terminal portion, wherein the busbar portion is configured to be arranged adjacent an end of an array of battery cells, and wherein the terminal portion is configured to provide a terminal of a battery pack.

In some aspects, the techniques described herein relate to a method, wherein the forming step includes configuring the busbar portion such that the busbar portion lies in a first plane, and configuring the terminal portion such that the terminal portion lies in a second plane perpendicular to the first plane.

In some aspects, the techniques described herein relate to a method, wherein: the forming step further includes providing the integrated component with a connector section connecting the busbar portion and the terminal portion by establishing a first bend between the busbar portion and the connector section and establishing a second bend between the connector section and the terminal portion, the first bend extends along a first axis substantially parallel to the first plane, and the second bend extends along a second axis substantially perpendicular to the first plane.

In some aspects, the techniques described herein relate to a method, wherein: the connector section lies in a third plane substantially perpendicular to the first and second planes.

### BRIEF DESCRIPTION OF THE DRAWINGS

FIG. 1 schematically illustrates an electrified vehicle.

FIG. 2 is a perspective view of a battery pack for an electrified vehicle.

FIG. 3 is a cross-sectional view of the battery pack of FIG. 2.

FIG. 4 is a perspective view of a portion of an assembly of this disclosure.

FIG. 5 is a perspective view of an example integrated component, which provides a both busbar and a terminal.

### DETAILED DESCRIPTION

This disclosure relates generally to electrified vehicles, and more specifically relates to an integrated busbar and terminal. A corresponding method is also disclosed. The disclosed design reduces packaging requirements, provides a smooth transitions to reduce localized temperatures, and reduces contact resistance that may otherwise be present between a separate busbar and a terminal. These and other benefits will be appreciated from the following description.

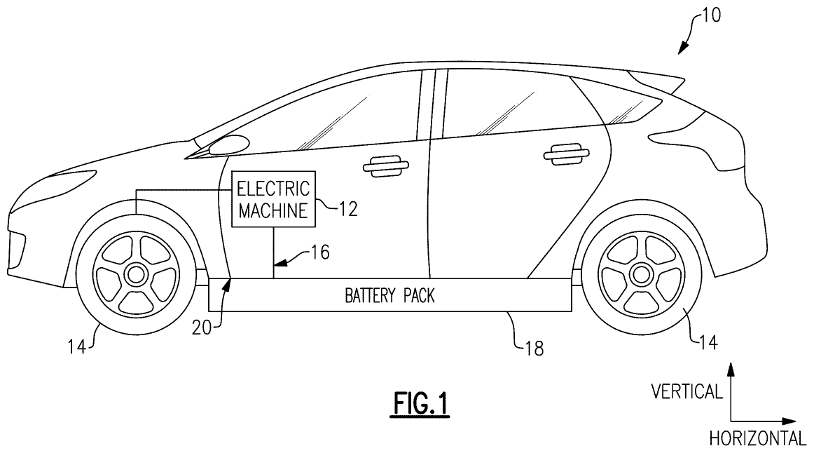

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEVs), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

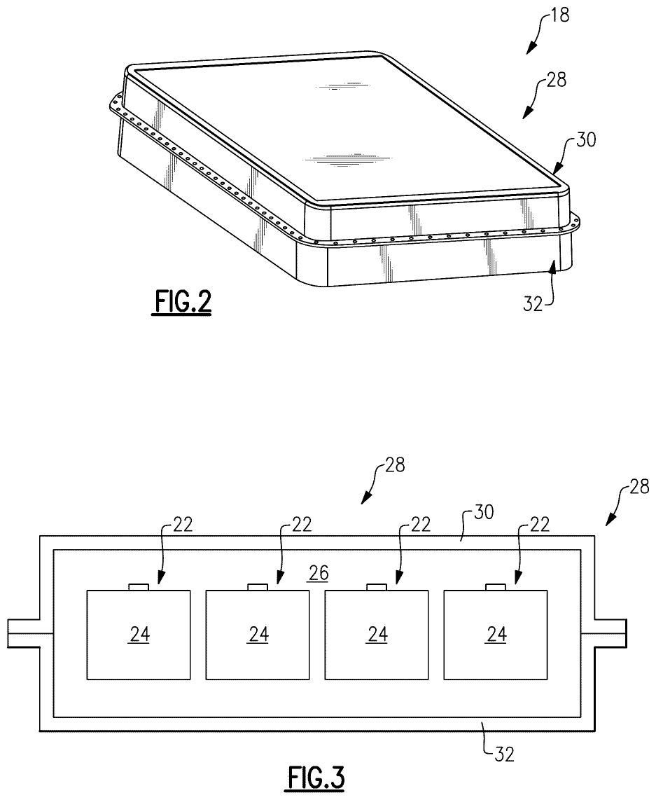

FIGS. 2 and 3 illustrate additional details associated with the traction battery pack 18 of the electrified vehicle 10. The traction battery pack 18 may include one or more battery arrays 22 (e.g., battery assemblies or groupings of rechargeable battery cells 24) capable of outputting electrical power to power the electric machine 12 and/or other electrical loads of the electrified vehicle 10. Other types of energy storage devices and/or output devices could alternatively or additionally be used to electrically power the electrified vehicle 10.

The battery cells 24 may be stacked side-by-side along a stack axis to construct a grouping of battery cells 24, sometimes referred to as a “cell stack.” In the highly schematic depiction of FIG. 3, the battery cells 24 are stacked in a direction into the page to construct each battery array 22, and thus the battery arrays 22 may extend in cross-car direction. However, other configurations may also be possible. The total number of battery arrays 22 and battery cells 24 provided within the traction battery pack 18 is not intended to limit this disclosure.

In an embodiment, the battery cells 24 of each battery array 22 are pouch style, lithium-ion cells. However, battery cells having other geometries (cylindrical, prismatic, etc.), other chemistries (nickel-metal hydride, lead-acid, etc.), or both could alternatively be utilized within the scope of this disclosure. That said, this disclosure has particular benefits in the context of pouch style cells.

The battery arrays 22 and various other battery internal components (e.g., bussed electrical center, battery electric control module, wiring, connectors, etc.) may be housed within an interior area 26 of an enclosure assembly 28. The enclosure assembly 28 may include an enclosure cover 30 and an enclosure tray 32. The enclosure cover 30 may be secured (e.g., bolted, welded, adhered, etc.) to the enclosure tray 32 to provide the interior area 26. The size, shape, and overall configuration of the enclosure assembly 28 is not intended to limit this disclosure.

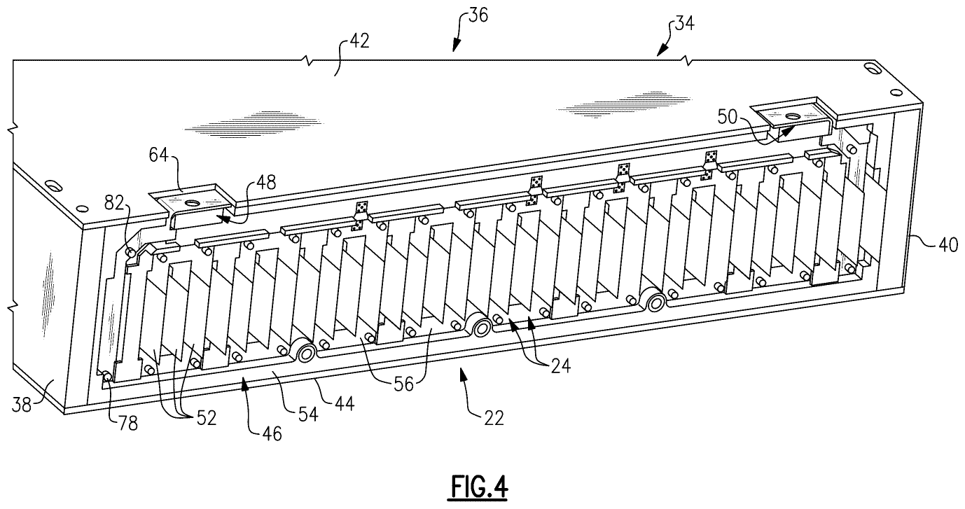

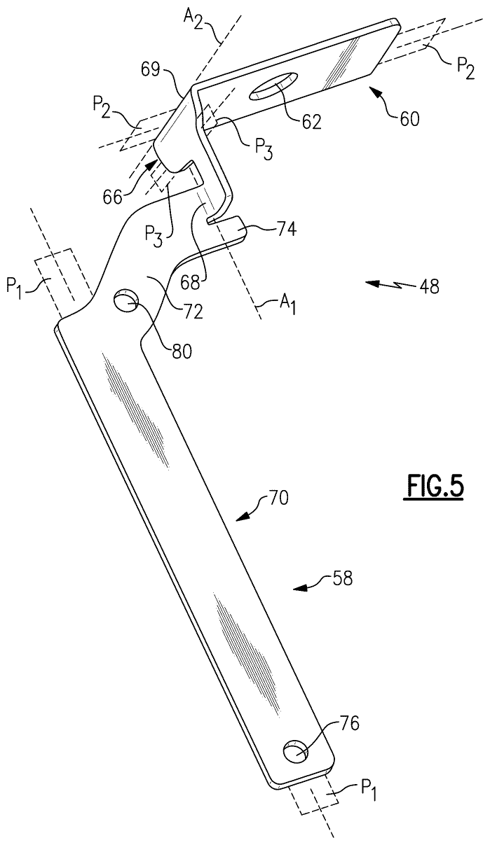

FIG. 4 illustrates a portion of an assembly 34 corresponding to one of the battery arrays 22. In particular, the assembly 34 includes an enclosure assembly 36 including a first end plate 38, a second end plate 40 opposite the first end plate 38, a top cover 42, a bottom plate 44 opposite the top cover 42, and a side 46. In FIG. 4, a side wall covering the side 46 is removed to show the components within the side wall. The enclosure assembly 36 may be contained within the enclosure assembly 28, or integrated into the enclosure assembly 28. While only one side of the enclosure assembly 36 is shown, it should be understood that the opposite side of the assembly 34 is configured substantially similarly to the side 46.

In one embodiment, the opposite side does not include the integrated components of this disclosure, providing the assembly 34 with a total of two integrated components. In another embodiment, the opposite side may include one of the integrated components of this disclosure. In this example, side 46 includes two integrated components 48, 50.

The assembly 34 provides a portion of the battery pack 18. Within the enclosure assembly 36, the assembly 34 contains a plurality of battery cells 24 arranged to provide a battery array 22. Each battery cell 24 includes two tab terminals. As shown in FIG. 4, one tab terminal 52 (sometimes called “tabs”) from each battery cell 24 projects outwardly relative to side 46. The assembly 34 includes a busbar frame 54 configured to support a plurality of busbars 56. The tab terminals 52 are configured to be attached to one of the busbars 56, such as by laser welding.

In this embodiment, the assembly 34 includes first and second integrated components 48, 50 arranged adjacent ends of the battery array 22. The first and second integrated components 48, 50 each establish an integrated busbar and terminal.

In this example, all of the busbars 56, which only establish busbars and do not establish terminals, are between the first and second integrated components 48, 50. Further, the first integrated component 48 is arranged adjacent the first end plate 38, and the second integrated component 50 is arranged adjacent the second end plate 40. The first and second integrated components 48, 50 are configured to electrically couple to the busbars 56 and to provide a terminal of the assembly 34, and in turn to provide a terminals of the battery pack 18. The first integrated component 48 could provide a positive terminal of the assembly 34, and the second integrated component 50 could provide a negative terminal of the assembly 34, and vice versa. The first and second integrated components 48 can therefore electrically couple the assembly 34 to other battery arrays within the battery pack 18, or to other loads of the electrified vehicle 10.

Additional detail of the first integrated component 48 is shown relative to FIG. 5. It should be understood that the second integrated component 50 is a substantial mirror image of the first integrated component 48. Any additional integrated components of the assembly 34 or the battery pack 18 may be configured substantially similar to either the first or second integrated component 48, 50.

With reference to FIG. 5, the first integrated component 48 includes a busbar portion 58 and a terminal portion 60. The busbar portion 58 is arranged adjacent an end of the array 22 and is attached to the busbar frame 54. The busbar portion 58 lies in a first plane P1. When the first integrated component 48 is mounted to the assembly 34, the busbar portion 58 also lies in a common plane with the busbars 56. The busbar portion 58 is configured to facilitate attachment of the first integrated component 48 to either a tab terminal of one or more of the battery cells 24. The battery cells 24 are electrically coupled together via the busbars 56 and via busbars on the opposite side of the assembly 34.

The terminal portion 60 is configured to provide at least a portion of a terminal of the assembly 34. The terminal portion 60, in this example, includes a hole 62 configured to receive a fastener, such as a bolt, screw, terminal stud, etc. The terminal portion 60 lies in a second plane P2 substantially perpendicular to plane P1. When the first integrated component 48 is mounted to the assembly 34, the terminal portion 60 is recessed slightly relative to the top cover 42. The top cover 42 includes a cutout 64 configured to facilitate attachment to the terminal portion 60. Further, the second plane P2 is substantially parallel to the top cover 42. The cutout 64 may be electrically isolated by plastic or rubber gromets from the first integrated component 48.

The first integrated component 48 is integrally formed from a single piece of material, such as a metallic material, in this example. The entire first integrated component 48 exhibits a substantially constant thickness, in this example. The first integrated component 48 is formed without any joints or seams. The first integrated component 48 may be formed from a single stamping process, or from a plurality of processes, such as a plurality of stamping and bending processes.

The first integrated component 48 further includes, in this example, a connector section 66. The connector section 66 is arranged between the busbar portion 58 and the terminal portion 60. The connector section 66 is formed by providing a first bend 68 between the busbar portion 58 and the connector section 66, and a second bend 69 between the connector section 66 and the terminal portion 60. The first and second bends 68, 69 could be formed simultaneously or sequentially.

The first bend 68 is a substantially 90° bend. The first bend 68 exhibits a curvature and is not a sharp bend, in this example. The first bend 68 extends along a first axis A1 substantially parallel to the first plane P1 and substantially perpendicular to the second plane P2.

The second bend 69 is also a substantially 90° bend. The second bend 69 exhibits a curvature and is not a sharp bend, in this example. The second bend 69 extends along a second axis A2. The second axis A2 is substantially perpendicular to the first plane P1 and the first axis A1, and is substantially parallel to the second plane P2. The first and second bends 68, 69 are such that the connector section 66 lies in a third plane P3 substantially perpendicular to the first and second planes P1, P2.

In this example, the busbar portion 58 includes a substantially rectangular section 70 configured to facilitate attachment of one or more tab terminals 52 and/or one or more busbars 56 to the substantially rectangular section 70. The busbar portion 58 further includes an inclined section 72 projecting from the substantially rectangular section 70. The inclined section 72 projects from the substantially rectangular section 70 at a non−90° angle, in this example, toward the first bend 68. The substantially rectangular section 70 and the inclined section 72 both lie in the first plane P1.

Further, adjacent the first bend 68, the first integrated component 48 includes a tongue 74 configured for attachment to a voltage sensing circuit. The tongue 74 lies in the first plane P1. The tongue 74 projects to an opposite side of the first bend 68 as the inclined section 72.

In this example, the substantially rectangular 70 section includes a first hole 76 configured to receive a post 78 (FIG. 4) of the busbar frame 54. Further, the inclined section 72 includes a second hole 80 configured to receive another post 82 (FIG. 4) of the busbar frame 54. The posts 78, 82 may be heat stakes.

It should be understood that terms such as “about” and “substantially” are not intended to be boundaryless terms, and should be interpreted consistent with the way one skilled in the art would interpret those terms. Directional terms such as “above,” “upper,” “below,” “bottom,” etc., are used with reference to the arrangement of the corresponding components in the drawings and are not intended to otherwise be limiting.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

The invention claimed is:

1. A battery pack, comprising:
an array of battery cells; and
an integrated component including a busbar portion and a terminal portion, wherein the busbar portion is arranged adjacent an end of the array of battery cells, and wherein the terminal portion provides a terminal of the battery pack.

2. The battery pack as recited in claim 1, wherein:
the busbar portion lies in a first plane, and
the terminal portion lies in a second plane substantially perpendicular to the first plane.

3. The battery pack as recited in claim 2, wherein:
the integrated component includes a connector section connecting the busbar portion and the terminal portion,
the integrated component includes a first bend between the busbar portion and the connector section,
the first bend extends along a first axis substantially parallel to the first plane,
the integrated component includes a second bend between the connector section and the terminal portion, and
the second bend extends along a second axis substantially perpendicular to the first plane.

4. The battery pack as recited in claim 3, wherein the connector section lies in a third plane substantially perpendicular to the first and second planes.

5. The battery pack as recited in claim 3, wherein the busbar portion includes:
a substantially rectangular section configured to facilitate attachment of cell tabs to the substantially rectangular section, and
an inclined section between the substantially rectangular section and the first bend.

6. The battery pack as recited in claim 5, wherein, adjacent the first bend, the integrated component includes a tongue configured for attachment to a voltage sensing circuit.

7. The battery pack as recited in claim 5, wherein the substantially rectangular section includes a first hole configured to receive a post, and the inclined section includes a second hole configured to receive another post.

8. The battery pack as recited in claim 1, wherein the terminal portion includes a hole configured to receive a connector.

9. The battery pack as recited in claim 1, wherein the integrated component is formed without any joints or seams.

10. The battery pack as recited in claim 1, wherein the integrated component is formed from a single manufacturing process.

11. The battery pack as recited in claim 10, wherein the manufacturing process is stamping.

12. The battery pack as recited in claim 1, wherein:
the integrated component is a first integrated component,
the battery pack further comprises a second integrated component including a busbar portion and a terminal portion, and
the busbar portion of the second integrated component is arranged adjacent an end of the array of battery cells opposite the end at which the busbar portion of the first integrated component is arranged.

13. The battery pack as recited in claim 1, wherein:
the integrated component is a first integrated component,
the battery pack further comprises a second integrated component including a busbar portion and a terminal portion,
the terminal portion of the first integrated component provides one of a positive terminal and a negative terminal of the battery pack, and
the terminal portion of the second integrated component provides the other of the positive terminal and the negative terminal of the battery pack.

14. An integrated component for a battery pack of an electrified vehicle, comprising:
a busbar portion; and
a terminal portion, wherein the integrated component is formed without any joints or seams.

15. The integrated component as recited in claim 14, wherein:
the busbar portion lies in a first plane, and
the terminal portion lies in a second plane perpendicular to the first plane.

16. The integrated component as recited in claim 15, further comprising a connector section connecting the busbar portion and the terminal portion, and wherein:
the integrated component includes a first bend between the busbar portion and the connector section,
the first bend extends along a first axis substantially parallel to the first plane,
the integrated component includes a second bend between the connector section and the terminal portion, and
the second bend extends along a second axis substantially perpendicular to the first plane.

17. A method, comprising:
forming an integrated component including a busbar portion and a terminal portion, wherein the busbar portion is configured to be arranged adjacent an end of an array of battery cells, and wherein the terminal portion is configured to provide a terminal of a battery pack.

18. The method as recited in claim 17, wherein the forming step includes configuring the busbar portion such that the busbar portion lies in a first plane, and configuring the terminal portion such that the terminal portion lies in a second plane perpendicular to the first plane.

19. The method as recited in claim 18, wherein:
the forming step further includes providing the integrated component with a connector section connecting the busbar portion and the terminal portion by establishing a first bend between the busbar portion and the connector section and establishing a second bend between the connector section and the terminal portion,
the first bend extends along a first axis substantially parallel to the first plane, and
the second bend extends along a second axis substantially perpendicular to the first plane.

20. The method as recited in claim 19, wherein:
the connector section lies in a third plane substantially perpendicular to the first and second planes.
